(19) United States
(12) Patent Application Publication
(10) Pub. No.: US 2024/0154657 A1
(43) Pub. Date: May 9, 2024

(54) INDICATING PRECODING TYPES

(71) Applicant: QUALCOMM Incorporated, San Diego, CA (US)

(72) Inventors: Ahmed ELSHAFIE, San Diego, CA (US); Yu ZHANG, San Diego, CA (US); Hwan Joon KWON, San Diego, CA (US)

(21) Appl. No.: 18/548,649

(22) PCT Filed: Apr. 12, 2021
(86) PCT No.: PCT/CN2021/086566

§ 371 Date: Sep. 1, 2023

(51) Int. Cl. H04B 7/0456

(52) U.S. Cl. CPC H04B 7/0456

(57) ABSTRACT

Aspects of the present disclosure provide apparatus, methods, processing systems, and computer readable mediums for indicating or switching among or between different precoding types for one or more communication elements. The one or more communication elements may be antennas of a wireless communication device (e.g., a UE or a BS) or elements of a reconfigurable intelligent surface (RIS). Techniques herein relate to indicating to one or more devices which precoding type to use for precoding one or more communication elements. For example, the techniques herein may be used for precoding communication elements of any suitable wireless communication device, such as antennas of a UE or BS, or RIS elements of a RIS.

### INTRODUCTION

Aspects of the present disclosure relate to wireless communications, and more particularly, to precoding techniques.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved communications between devices in a wireless network.

Certain aspects provide a wireless communication device including a memory and a processor coupled to the memory. The memory and the processor are generally configured to transmit, to a computing device, an indication indicating at least one precoding type to use for precoding one or more communication elements associated with the computing device. The at least one precoding type includes at least one of a non-codebook based precoding or a codebook based precoding. The memory and the processor are further configured to communicate, with the computing device, data associated with the computing device or another computing device.

Certain aspects provide a computing device including a memory and a processor coupled to the memory. The memory and the processor are configured to: receive, from a wireless communication device, an indication indicating at least one precoding type to use for precoding one or more communication elements associated with the computing device. The at least one precoding type includes at least one of a non-codebook based precoding or a codebook based precoding. The memory and the processor are further configured to precode the one or more communication elements based on the indication indicating the at least one precoding type.

Certain aspects provide a method for wireless communications by a wireless communication device. The method generally includes transmitting, to a computing device, an indication indicating at least one precoding type to use for precoding one or more communication elements associated with the computing device. The at least one precoding type includes at least one of a non-codebook based precoding or a codebook based precoding. The method further includes communicating, with the computing device, data associated with the computing device or another computing device.

Certain aspects provide a method for wireless communications by a computing device. The method generally includes receiving, from a wireless communication device, an indication indicating at least one precoding type to use for precoding one or more communication elements associated with the computing device. The at least one precoding type includes at least one of a non-codebook based precoding or a codebook based precoding. The method further includes precoding the one or more communication elements based on the indication indicating the at least one precoding type.

Certain aspects provide a wireless communication device for wireless communications. The wireless communication device includes means for transmitting, to a computing device, an indication indicating at least one precoding type to use for precoding one or more communication elements associated with the computing device. The at least one precoding type includes at least one of a non-codebook based precoding or a codebook based precoding. The wireless communication device includes means for communicating, with the computing device, data associated with the computing device or another computing device.

Certain aspects provide a computing device for wireless communications. The computing device includes means for receiving, from a wireless communication device, an indication indicating at least one precoding type to use for precoding one or more communication elements associated with the computing device. The at least one precoding type includes at least one of a non-codebook based precoding or a codebook based precoding. The computing device includes means for precoding the one or more communication elements based on the indication indicating the at least one precoding type.

Certain aspects of the present disclosure provide a non-transitory computer readable medium storing instructions that when executed by a computing device as discussed herein cause the computing device to communicate wirelessly. For example, the non-transitory computer readable medium stores instructions that, when executed by a computing device, cause the computing device to transmit, to a computing device, an indication indicating at least one precoding type to use for precoding one or more communication elements associated with the computing device. The at least one precoding type includes at least one of a non-codebook based precoding or a codebook based precoding. The non-transitory computer readable medium stores instructions that, when executed by a computing device, further cause the computing device to communicate, with the computing device, data associated with the computing device or another computing device.

Certain aspects of the present disclosure provide a non-transitory computer readable medium storing instructions that when executed by a computing device as discussed herein cause the computing device to communicate wirelessly. For example, the non-transitory computer readable medium stores instructions that, when executed by a computing device, cause the computing device to receive, from a wireless communication device, an indication indicating at least one precoding type to use for precoding one or more communication elements associated with the computing device. The at least one precoding type includes at least one of a non-codebook based precoding or a codebook based precoding. The non-transitory computer readable medium stores instructions that, when executed by a computing device, further cause the computing device to precode the one or more communication elements based on the indication indicating the at least one precoding type.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, including a reconfigurable intelligent surface (RIS), in accordance with certain aspects of the present disclosure.

FIG. 2 is a block diagram conceptually illustrating a design of an example base station (BS), user equipment (UE), and RIS, in accordance with certain aspects of the present disclosure.

FIG. 3A illustrates an example of communication blockage between wireless communication devices.

FIG. 3B illustrates an example of using a RIS to overcome impediment by obstacles between a BS and a UE, according to certain aspects of the present disclosure.

FIG. 4 illustrates an example arrangement of RIS elements, in accordance with certain aspects of the present disclosure.

FIGS. 5A and 5B illustrate an example training operation for precoding RIS elements, in accordance with certain aspects of the present disclosure.

FIG. 6 is a flow diagram illustrating example operations by a configuring device (e.g., a BS or UE) to configure a computing device to use a particular precoding type, in accordance with certain aspects of the present disclosure.

FIG. 7 is a flow diagram illustrating example operations by a configured device (e.g., a RIS controller, RIS, UE, or BS) to configure use of a particular precoding type, in accordance with certain aspects of the present disclosure.

FIG. 8 illustrates an example call flow for changing precoding types, in accordance with certain aspects of the present disclosure.

FIG. 9 illustrates an example signaling for configuring different precoding types, in accordance with certain aspects of the present disclosure.

FIG. 10 illustrates an example configuration of RIS groups, in accordance with certain aspects of the present disclosure.

FIG. 11 illustrates an example indication of switching time, in accordance with certain aspects of the present disclosure.

FIG. 12 illustrates a communications device that may include various components configured to perform operations for the techniques disclosed herein.

FIG. 13 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for indicating or switching among/between different precoding types for one or more communication elements. The one or more communication elements may be antennas of a wireless communication device (e.g., a UE or a BS) or elements of a reconfigurable intelligent surface (RIS).

Communication elements may be precoded (e.g., beamformed) by identifying for each communication element a particular phase shift value, weight (e.g., amplitude gain), and/or the like (collectively referred to as precoding values) to apply to a signal communicated (e.g., transmitted, received, reflected) by the communication element. The precoding may cause a signal communicated by the communication elements to be beamformed in a particular direction.

Precoding values to apply to communication elements may be determined based on a precoding type used, such as codebook based precoding or non-codebook based precoding. In codebook based precoding, predetermined sets of precoding values may be indexed in a data structure identified as a “codebook” and therefore the precoding values are limited to those indicated in the codebook. Codebook based precoding can help limit the number of options for precoding communication elements, thereby making it more efficient to select precoding values. In non-codebook based precoding, any precoding values may be used for precoding, thereby potentially leading to precoding values that result in better signal quality.

Techniques herein relate to indicating to one or more devices which precoding type to use for precoding one or more communication elements. The techniques herein may be used for precoding communication elements of any suitable wireless communication device, such as antennas of a UE or BS, or RIS elements of a RIS. A wireless communication device is a type of computing device that performs wireless communication. In some aspects, a wireless communication device may also have a wired connection to perform wired communications.

Aspects are discussed herein with respect to a configuring device (e.g., a BS or UE) that configures a configured device (e.g., BS, UE, or RIS controller) to use a particular precoding type. The configuring device may use wireless or wired communications to configure the configured device in various aspects. Further, in certain aspects, the communication elements of the configured device may be integrated with the configured device, or may be coupled to the configured device by a connection (e.g., wired connection). For example, a RIS controller may be coupled to the RIS elements that it controls by precoding. The combination of a RIS controller and RIS elements, may simply be referred to as a RIS. Certain aspects are discussed herein with respect to a RIS controller as the configured device, and RIS elements as communication elements, however it should be understood that such aspects can similarly be applicable to other configured devices and/or communication elements.

A RIS may be configured or reconfigured to use a particular precoding type, such as for a particular time period. The present disclosure provides techniques to indicate, control, or configure precoding types to use for such precoding in a RIS. For example, a wireless communication device (e.g., a BS or UE) may transmit to a computing device (e.g., a BS, UE, RIS controller, or RIS) an indication indicating at least one precoding type to use for precoding one or more communication elements associated with the computing device. The wireless communication device may communicate with the computing device data associated with the computing device or another computing device.

At a high level, a RIS includes a number of elements (referred to as RIS elements), which form a surface that may be integrated into different objects such as walls, sidings, clothes, etc. The RIS elements are reconfigurable scatterers, including antennas that receive and re-radiate (e.g., reflect or refract) radio wave signals. The RIS elements may be passive, such that no external power is required for the re-radiation, and such that the re-radiation is configurable with a phase shift for each RIS element. The RIS element may also be active, such that the re-radiation may change the amplitude in addition to the phase shift. The RIS elements may therefore perform constructive interference that resembles beamforming and re-radiate beams in certain directions from a transmitter (e.g., a UE or BS) toward a receiver (e.g., a BS or UE). Such beamforming or precoding of the RIS elements is controlled by identifying phase shift values, or weights, to be applied to corresponding RIS elements given specific conditions of the transmitter and the receiver. The present disclosure provides techniques for indicating a precoding type, such as codebook based or non-codebook based precoding weights to be used by the RIS elements in order to provide an efficient or optimized re-radiation when multiple computing devices are involved.

For example, a RIS may be configured to support codebook based or non-codebook based precoding and may not change to a different precoding scheme during operation. The present disclosure provides signaling techniques to allow the RIS controller to change the type of precoding to be used at the RIS. For example, the RIS controller may use codebook based and non-codebook based precodings at different times, such as based on receiving indications of durations for which to use corresponding precoding types. In some cases, a wireless communication device, may signal such indications. In certain aspects, the indications may include a sequence of transitioning/switching of precoding types and the corresponding durations. Details of various implementations are presented below.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

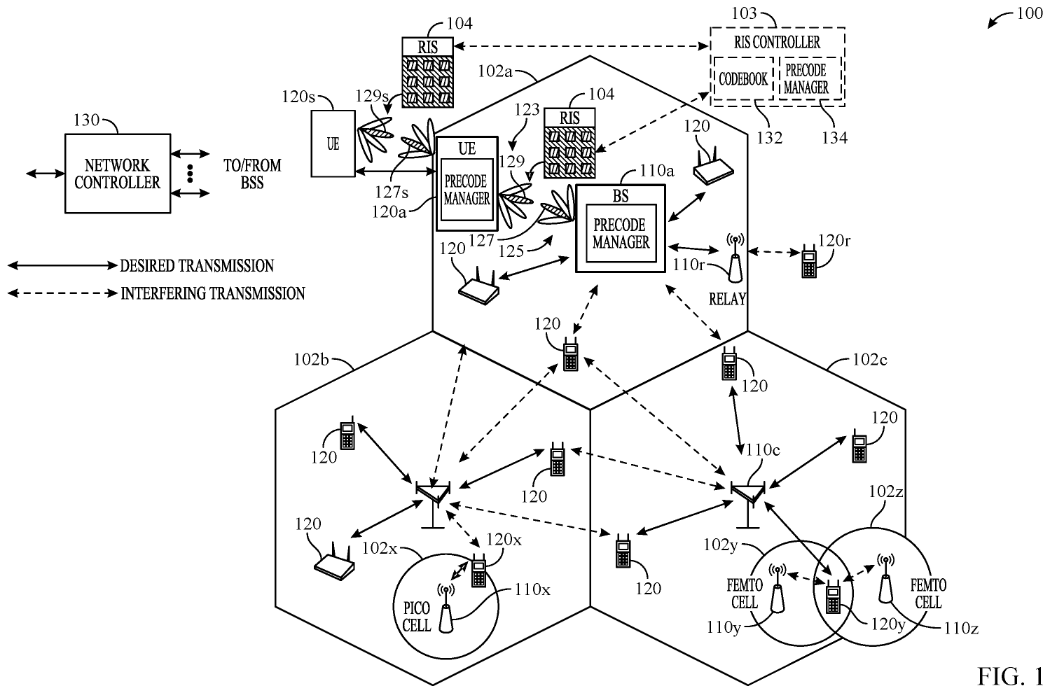

FIG. 1 illustrates an example wireless communication network 100 in which aspects of the present disclosure may be performed. For example, the wireless communication network 100 may be a New Radio (NR) or 5G network. As shown in FIG. 1, a user equipment (UE), such as the UE 120 (e.g., including the UEs 120a and 120s) in the wireless communication network 100 communicates with a serving base station (BS), such as the BS 110a in a cell 102a in the wireless communication network 100. The UE 120a may be configured with multiple transmission configurations (e.g., antenna arrays/panels and/or beams) for uplink transmission to the BS 110a. In some cases, the UE 120a may be configured with multiple transmission configurations for sidelink transmission to another UE 120s.

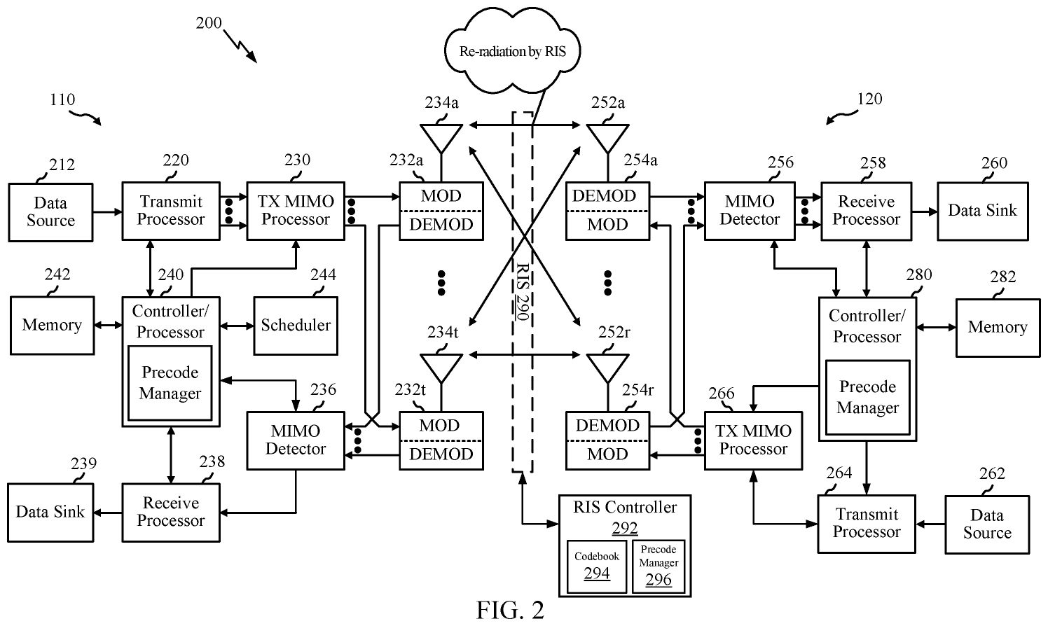

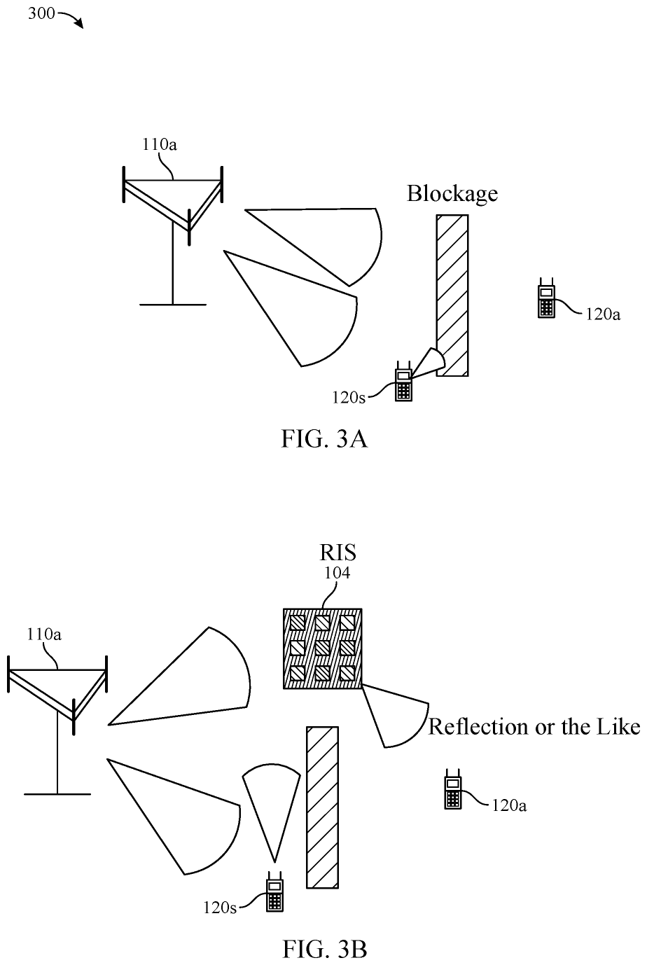

In certain aspects, communication between the BS 110a (e.g., gNB) and the UE 120a may be blocked by obstacles and require assistance from a reconfigurable intelligent surface (RIS) 104 (also shown in FIGS. 2 and 3). The RIS 104 enables communications between the BS 110a and UE 120a to be received and re-radiated, thereby avoiding the obstacles. For example, the RIS 104 may be configured with a codebook for precoding one or more elements thereon (referred to as MS elements) to allow a beam from one of the BS 110a and UE 120a (e.g., a transmitter) to be re-radiated off the MS to reach the other one of the BS 110a and UE 120a (e.g., a receiver). The direction of the re-radiation by the RIS 104 may be controlled or reconfigured by the MS controller 103 of the RIS 104. The RIS controller 103 includes a codebook 132 and a precode manager 134 for applying precoding according to a precoding type, such as a codebook based precoding or a non-codebook based precoding, to the RIS elements of the RIS 104. The codebook 132 includes values of weights to configure each RIS element to modify the radio signal re-radiated by each RIS element, such as weight shifting or changing amplitudes. The precode manager 134 may use different precoding types when provided indications or under different conditions.

In an example, when the UE 120a is the transmitter and communicates with the BS 110a (e.g., over a wireless Uu interface), the BS 110a is the receiver that provides the RIS controller 103 feedback for selecting precoding values for the RIS elements. Similarly, when the UE 120a establishes a sidelink (e.g., PC5 interface) with the UE 120s, the UE 120a may be the transmitter and the UE 120s may be the receiver that provides the RIS controller 103 feedback. The codebook 132 may be generated based on specific settings of the BS 110a and the UE 120a, and based on different parameters specific to situations. The present disclosure provides techniques for generating or designing the codebook 132.

The feedback from the receiver to the RIS controller 103 allows for the selection of precoding values for reflecting communications between the transmitter and the receiver. For example, the UE 120a may send a series of reference signals (RSs) in one or more directions 129 in a training session 123. Via the re-radiation (e.g., reflection or refraction) by the RIS 140, the BS 110a receives the RSs. The re-radiation by the RIS is controlled by a RIS controller that may apply different weights to the RIS elements, causing different phase shifts, and therefore different beamforming characteristics for the RSs to reach the BS 110a. The BS 110a may evaluate the RSs using one or more metrics, such as a signal strength, an energy level, a signal to noise ratio (SNR), a channel quality indicator (CQI), or a reference signal received power (RSRP).

The BS 110a may use one of the metrics as feedback to inform the RIS controller 103 on which set of weights may be preferred for communication between the UE 120a and the BS 110a. Similarly, the BS 110a may be a transmitter and send RSs in one or more directions 127 for the UE 120a to receive, such as in a training session 125 corresponding to the training session 123. When training with a RIS controller in sidelink situations, the UE 120s may be a transmitter and send RSs in one or more directions 129s; and the UE 120a may be a transmitter and send RSs in one or more directions 127s. Other configurations in system 100 can be similarly setup between the UEs 120 and BSs 110.

The BS 110a and the UE 120a may respectively include a precode manager for indicating one or more precoding types to the RIS controller 103. The respective precode managers may determine and/or generate signaling for indicating the desired precoding types.

As illustrated in FIG. 1, the wireless communication network 100 may include a number of BSs 110 and other network entities. ABS may be a station that communicates with UEs. Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120a, 120s, 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving B S, which is a BS designated to serve the UE on the downlink and/or uplink. A finely dashed line with double arrows indicates interfering transmissions between a UE and a BS.

FIG. 2 is a block diagram 200 illustrating example components of BS 110 and UE 120 (as depicted in FIG. 1), which may be used to implement aspects of the present disclosure. As shown, the RIS 290 may assist the communications, by receiving and re-radiating radio signals, between the BS 110 and UE 120, such as when such communications are impeded or blocked by obstacles (not shown, illustrated as the blockage in FIGS. 3A and 3B). For example, the RIS 290 may re-radiate the transmissions from one of the BS 110 or UE 120 to the other using reflection, refraction, or other passive or active mechanisms.

The RIS 290 may be reconfigured or controlled by a RIS controller 292. Each RIS element may re-radiate radio signals with certain phase or amplitude changes, such as phase shifts. The RIS controller 292 may reconfigure the phase or amplitude changes by applying a precoding weight to each RIS element to enable the RIS 290 to re-radiate an output beam at different directions given a particular input beam. An illustrative deployment example of the RIS 290 is shown in FIG. 3B. According to the present disclosure, the RIS controller 292 includes a precode manager 296 and a codebook 294. The precode manager 296 may manage precoding types, such as using a codebook based or noncodebook based precoding type to determine precoding for the RIS 290. In some cases, the precode manager 296 may also select or generate codebooks 294 specific to incoming reference signals, such as the reference signals transmitted by a transmitter (either the BS 110 or the UE 120). The generated codebooks 294 may be stored in the RIS controller 292 for future use in conditions similar to when the codebooks 294 are generated.

The antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein. Although the present disclosure uses RIS as an example of implementing the precoding techniques, the techniques may apply to another form of cooperative communications, such as transparent relaying or regenerative relaying implementations. As shown in FIG. 2, the controller/processor 280 has a precode manager that may indicate a precoding type to a MS controller 292 configured to adjust weights on the MS elements, as described in more detail herein.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The processor 220 may also generate reference symbols, e.g., for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the base station 110 and may provide received signals to the demodulators (DEMODs) in transceivers 254a through 254r, respectively. Each demodulator in transceivers 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a through 254r (e.g., for SC-FDM, etc.), and transmitted to the base station 110.

At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The processor 240 and/or other processors and modules at the BS 110 may perform or direct the execution of processes for the techniques described herein. For example, as shown in FIG. 2, the processor 240 has a precode manager that may indicate precoding types to a RIS controller 292 configured to adjust weights on the RIS elements, as described in more detail herein. The memories 242 and 282 may store data and program codes for BS 110 and UE 120, respectively. A scheduler 244 may schedule UEs for data transmission on the downlink and/or uplink.

### Example Application and Precoding of Reconfigurable Intelligent Surface (RIS)

As discussed above, massive multiple input multiple output (MIMO) configuration increases throughput. For example, MIMO can achieve high beamforming gain by using active antenna units and can operate with individual radio frequency (RF) chains for each antenna port. To extend coverage, RISs may be deployed to reflect impinging waves in desired directions. In some cases, RISs may operate without substantial power consumption when they operate passively to only reflect or refract beams from the transmitter toward the receiver. In some cases, the reflection or refraction direction may be controlled by gNB or a monitoring sidelink UE.

FIG. 3A illustrates an example diagram 300 of communication blockage between wireless communication devices. As shown, impeded by a blockage, a first network entity (BS 110a) may only transmit to the UE 120s as transmissions may not reach the UE 120a, as the blockage prevents signals from reaching the UE 120a. The blockage also prevents the UE 120s from establishing sidelink communications with the UE 120a. As such, the UE 120a may not communicate with the BS 110a via the UE 120s using sidelink.

FIG. 3B illustrates an example of using a RIS 104 to overcome the blockage, according to certain aspects of the present disclosure. As shown, a RIS 104 is introduced to reflect or otherwise re-radiate the radio signals to bypass the blockage. For example, the two-way communications between the BS 110a and the UE 120a are enabled by the RIS 104 re-radiating one or more beams from the BS 110a toward UE 120a and vice versa. Furthermore, the RIS 104 can also be reconfigured, such as with different precoding values, to enable the UEs 120s and 120a to establish sidelink communications.

The RIS 104 may perform passive beamforming. For example, the RIS 104 may receive signal power from the transmitter (e.g., the BS 110a, UE 120a, or UE 120s) proportional to the number of RIS elements thereon. When the RIS 104 reflects or refracts the radio signal, the RIS elements cause phase shifts to perform conventional beamforming or precoding. The phase shifts are controlled by precoding weights (e.g., a multiplier or an offset of time delay) applied to the RIS elements. For an array of RIS elements, such as an m×n rectangular matrix, for example, a respective precoding weight may be generated or specified for each of the RIS element by the RIS controller.

The present disclosure provides different techniques for indicating one or more precoding types to use for precoding one or more communication elements, such as RIS elements or antennas. The switching or changing of different precoding types may be combined with the process of training, which includes identifying the (e.g., optimal) precoding parameters (e.g., identifying precoding weights, either codebook based or non-codebook based) to use for precoding the one or more communication elements. As discussed, the training may be a closed-loop operation performed in real-time, on demand, and/or when the pair of transmitter and receiver changes with respect to the RIS (e.g., movement or changes of the current pair, or a new transmitter or receiver joining the pair).

Before implementing the disclosed techniques, channel acquisition or beam training via the RIS can be challenging, because a RIS generally does not inherently have transceiver chains or sensing abilities to use conventional channel estimation methods. In addition, introducing the RIS to a pair of transmitter or receiver that can already communicate with each other but for the blockage can increase the number of channel coefficients proportional to the number of the RIS elements, causing potentially large overhead. The present disclosure provides techniques for indicating, selecting, and/or switching precoding types to enable precoding of the RIS elements to at least overcome these existing challenges, along with bringing other advantages as mentioned above.

### Example Precoding Indication and Training for Precoding RIS Elements

The present disclosure provides techniques for indicating at least one precoding type to use for precoding one or more communication elements, such as indicating a different precoding type than one currently configured. For example, the indication may switch precoding types between codebook based precoding and non-codebook based precoding. In a general aspect, a wireless communication device may transmit, to a computing device, an indication indicating at least one precoding type to use for precoding one or more communication elements associated with the computing device. The at least one precoding type comprises at least one of a non-codebook based precoding or a codebook based precoding. In some aspects, the wireless communication device may perform training with the computing device, to identify an (e.g., optimal) precoding setting (including precoding types and/or specific precoding weights) for the communication elements.

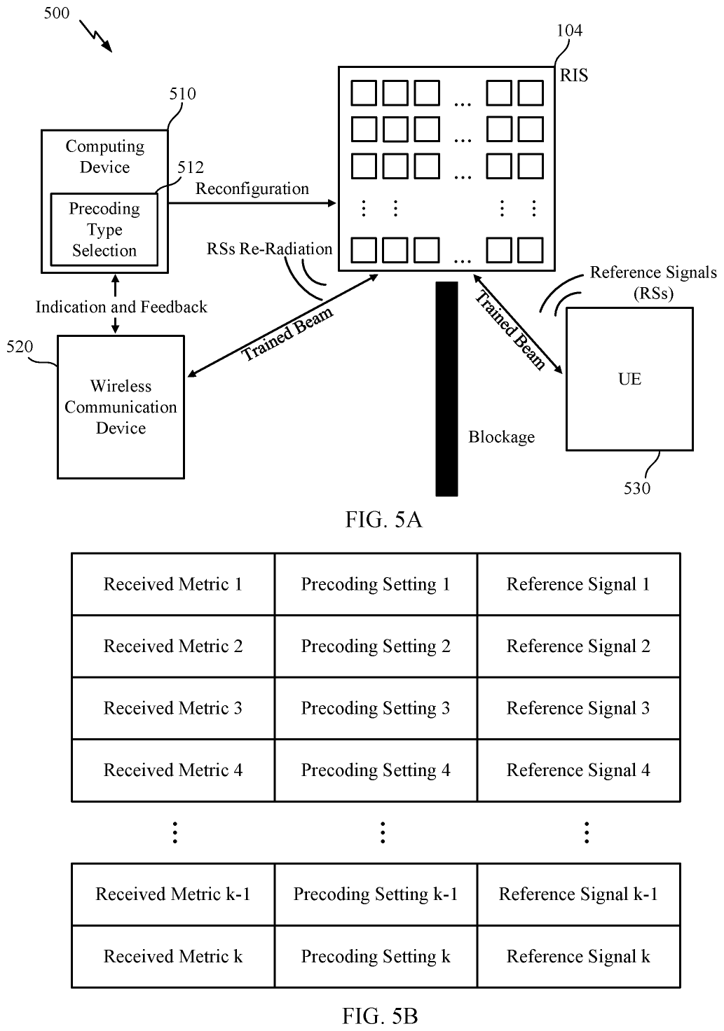

In some aspects, a controller may generate a codebook (applicable for either codebook based or non-codebook based precoding) for performing precoding of RIS elements. For example, the non-codebook based precoding, though it need not use a codebook for precoding, may still use a codebook for device feedback or training in some cases. The controller may participate in training between a transmitter and a receiver, by applying different precoding to the RIS elements, based on the codebook, while the transmitter transmits reference signals (RSs). The RSs may be re-radiated by the RIS elements to reach the receiver, regardless if the RSs would be blocked in a direct link. The receiver sends the controller feedback (such as the feedback from the first wireless communication device shown in FIG. 5A). The precoding applied to the RIS elements for communications between the transmitter and the receiver are based on the feedback and the codebook generated by the controller.

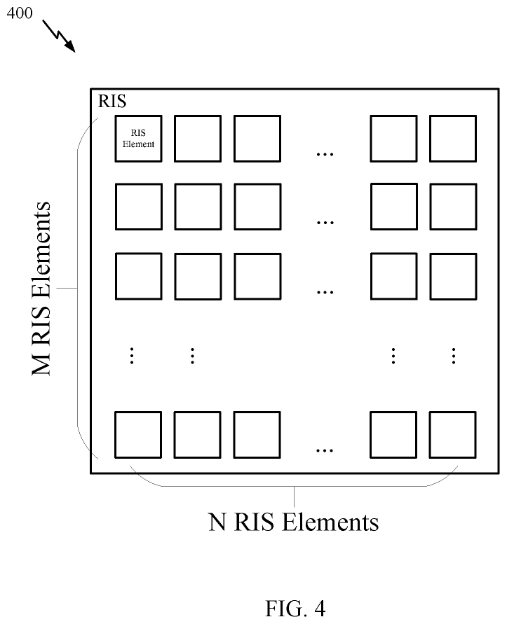

An example of a MS 400 of an array of N×M RIS elements is shown in FIG. 4. The MS controller may reconfigure the RIS 400 by applying different precoding weights to the MS elements (or at least a subset thereof), such that the beam direction of re-radiation may be altered. In one example, the RIS controller may generate or select a codebook based or non-codebook based matrix of size N×M, where N is the number of horizontal elements and M is the number of vertical elements. Although FIG. 4 illustrates the RIS 400 as a rectangular array, the disclosed precoding techniques herein are applicable to RIS of various element layouts or patterns.

FIGS. 5A and 5B illustrate an example training operation 500 for precoding RIS elements. As shown in FIG. 5A, a wireless communication device 520 (e.g., the base station 110a or the sidelink UE 120s of FIG. 3A) may be blocked by the blockage from communicating directly with a UE 530 (or a second computing device or wireless communication device).

In the example shown in FIG. 5A, the UE 530 transmits reference signals (RSs) to the RIS 104's direction. Each RS may be transmitted during an RS occasion (e.g., a resource set (e.g., time) in which an RS is transmitted) and have an associated index that identifies the RS based on the RS occasion in which it is transmitted. The RIS 104 re-radiates, in a different beam direction, the RSs to the wireless communication device 520. Upon receiving the RSs, the wireless communication device 520 may provide indication and/or feedback to the computing device 510, in order to alter or update the precoding settings in search for an optimal precoding configuration for the RIS 104. The feedback to the computing device 510 may be provided at the end of the training operation 500, where an indication of one or more of the indices associated with one or more of the RSs are fed back to the computing device 510 (e.g., RIS's controller) and/or to the wireless communication device 520. For example, an indication of one or more indices of one or more RSs that have the best (e.g., highest) measured metrics (e.g., a signal strength, an energy level, a signal to noise ratio (SNR), a channel quality indicator (CQI), or a reference signal received power (RSRP)) may be fed back. Then, the computing device 510 may use that (e.g., best) precoder that is associated/was for the one or more RSs by the RIS 104, the wireless communication device 520, or the UE 530.

For example, as shown in FIG. 5B, assuming that a number of k training times/occasions corresponding to RS occasions (e.g., indices 1, 2, 3, . . . k) are used to transmit RSs, after receiving the reflected RS signals, the UE 530 measures a metric for each RS. At the end of the training, the UE 530 or the wireless communication device 520 may send the index (from 1 to k) of the RS occasion/RS having a best (e.g., highest) measured metric (e.g., occasion m). Alternatively, a set of RS occasions/RSs, such as l best (e.g., highest measure metric) RS occasions/RSs may be indicated by indexes by the UE 530 or the wireless communication device 520. Where a set of RS occasions/RSs are identified, different precoders used for the different RS occasions/RSs may be identified, and ranked in order of the ranking of the RS occasions/RSs identified. The computing device 510 may then use one of the identified precoders (e.g., associated with the highest ranking RS occasion/RS) in serving UE 530.

For example, the computing device 510 may include a precoding type selection module 512 for selecting a codebook based or non-codebook based precoding and/or generation of a corresponding codebook for applying precoding weights to the RIS elements. In some cases, assuming the RSs sent from the UE 530 remain constant in values and in direction, changing the precoding type and the corresponding weight values may change the re-radiation by the RIS elements. The re-radiated RSs are measured at the wireless communication device 520, such as to measure certain metrics, such as energy or signal to noise ratios, for identifying a RS that optimizes such metrics. That RS may be associated with a particular precoding setting/weights at the RIS 104. Therefore, the wireless communication device 520 may indicate the RS to the RIS 104, and the associated precoding weights may be used for communication between the wireless communication device 520 and the UE 530.

As shown in FIG. 5B, multiple different precoding settings may be applied to the RIS 104 with respect to the sequence of RSs. Correspondingly, the wireless communication device 520 may measure a receiving metric corresponding to each of the re-radiated RSs. As illustrated, for 1 through k RSs, the received metrics may be used to identify one precoding setting that generates an optimal value. The training process completes when the optimal value is identified for the pair of the first and second wireless communication devices with respect to the RIS 104. Upon completion, as shown in FIG. 5A, the wireless communication device 520 may communicate in a trained beam with the RIS 104, which may communicate in a trained beam with the UE 530.

In some aspects, the wireless communication device 520 may be a base station, such as BS 110 of FIG. 1, or a monitoring sidelink UE, such as UE 120a of FIG. 1. The UE 530 may be a corresponding UE in communication with the wireless communication device 520. The computing device 510 may be a MS controller, such as a dedicated MS controller wirelessly or by wire in communication with the MS 104, or a component of the wireless communication device 520 (e.g., when a BS may directly control or reconfigure the RIS 104).

In some cases, the wireless communication device 520 and the UE 530 may agree on a sequence of indices of precoding settings to be used, based on the generation or selection of precoding weights, so that at a reference signal j (sent at a certain time within a series of times) may be associated with the sequence of indices of weights. As such, the computing device 510 (e.g., the RIS controller) knows the corresponding precoding weights and can correctly use or apply the weights.

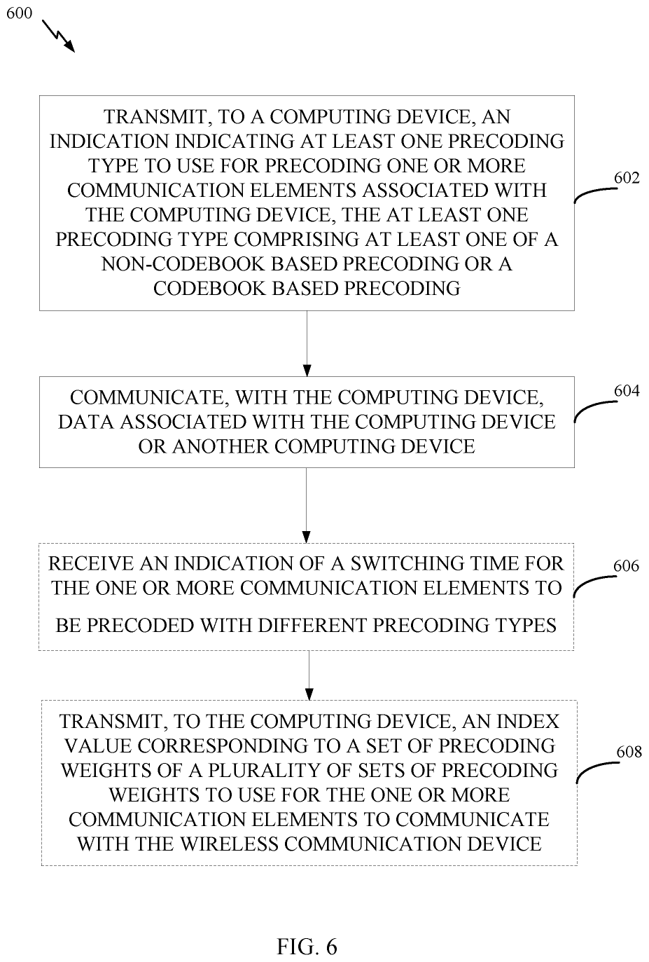

FIG. 6 is a flow diagram illustrating example operations 600 for wireless communication, in accordance with certain aspects of the present disclosure. The operations 600 may be performed by a wireless communication device (e.g., a base station or a UE), such as the base station 110 or the UE 120. For example, viewing FIGS. 3B and 5A together, the wireless communication device may be the BS 110a or the sidelink UE 120s, when the UE 120a is the second wireless communication device.

Operations 600 may be implemented as software components that are executed and run on one or more processors (e.g., controller/processor 240 or 280 of FIG. 2). Further, the transmission and reception of signals by the wireless communication device in operations 800 may be enabled, for example, by one or more antennas (e.g., antennas 234 or 252 of FIG. 2). In certain aspects, the transmission and/or reception of signals by the wireless communication device may be implemented via a bus interface of one or more processors (e.g., controller/processor 240 or 280) obtaining and/or outputting signals.

The operations 600 begin, at 602, by transmitting, to a computing device, an indication indicating at least one precoding type to use for precoding one or more communication elements associated with the computing device. The at least one precoding type may include at least one of a non-codebook based precoding or a codebook based precoding. The computing device may be one of a base station (e.g., BS 110), a user equipment (e.g., UE 120), or a controller of a RIS (e.g., MS controller 292 of FIG. 2). In some aspects, the communication elements may be MS elements on a RIS (e.g., MS 290), reconfigurable by the MS controller. In some aspects, the one or more communication elements include one of: one or more antennas or one or more MS elements. In certain aspects, the computing device transmits an indication indicating a non-codebook based precoding type for precoding the one or more communication elements associated with the computing device. In certain aspects, the computing device transmits an indication indicating a codebook based precoding type for precoding the one or more communication elements associated with the computing device. For example, the transmission

At 604, the wireless communication device communicates, with the computing device, data associated with the computing device or another computing device. In some cases, the other computing device may include one of a base station or a UE.

At 606, operations 600 optionally continue by receiving, at the wireless communication device, an indication of a switch time for the one or more communication elements to be precoded with different precoding types.

At 608, operations 600 optionally continue by transmitting, to the computing device, an index value corresponding to a set of precoding weights of a plurality of sets of precoding weights to use for the one or more communication elements to communicate with the wireless communication device. A set of precoding weights may include one or more precoding weights.

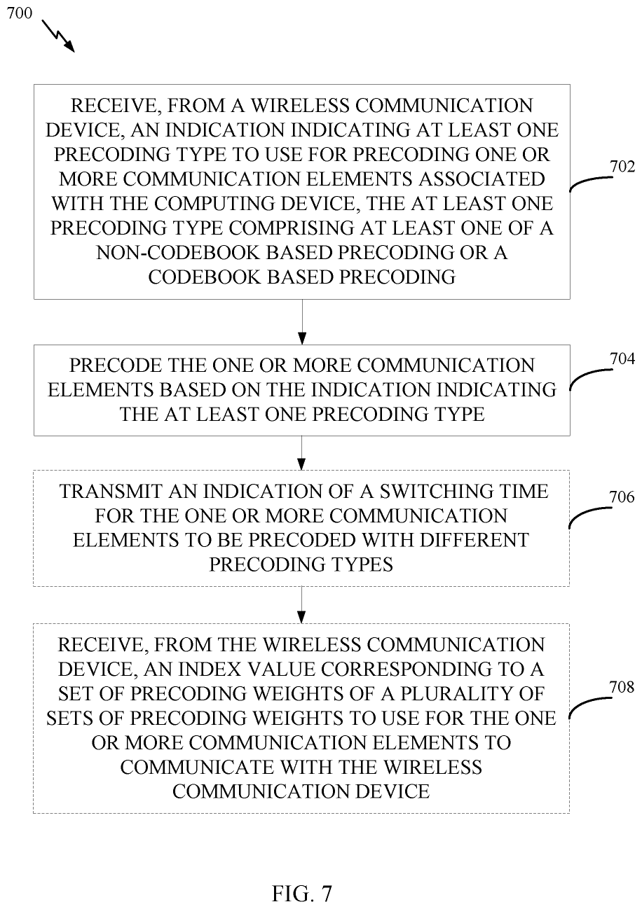

FIG. 7 is a flow diagram illustrating example operations 700 for wireless communication, in accordance with certain aspects of the present disclosure. The operations 700 may be performed by a computing device, such as one of a base station, a user equipment, or a controller of a MS. In some cases, the computing device may be the RIS controller 103 of FIG. 1 or the MS controller 292 of FIG. 2. Although the RIS controller 103 or 292 is illustrated as a separate and independent device, in some cases, the MS controller 103 or 292 may be integrated with each RIS. In some cases, the UE 120 or the BS 110 may perform operations 700 as a RIS controller (e.g., when the UE 120 or the BS 110 includes an internal RIS controller module).

The operations 700 begin, at 702, by receiving, from a wireless communication device, an indication indicating at least one precoding type to use for precoding one or more communication elements associated with the computing device. The at least one precoding type includes at least one of a non-codebook based precoding or a codebook based precoding.

At 704, operations 700 continue by precoding the one or more communication elements based on the indication indicating the at least one precoding type.

At 706, operations 700 may optionally continue by transmitting an indication of a switching time for the one or more communication elements to switch between using different precoding types.

At 708, operations 700 may optionally continue by receiving, from the wireless communication device, an index value corresponding to a set of precoding weights of a plurality of sets of precoding weights to use for the one or more communication elements to communicate with the wireless communication device.

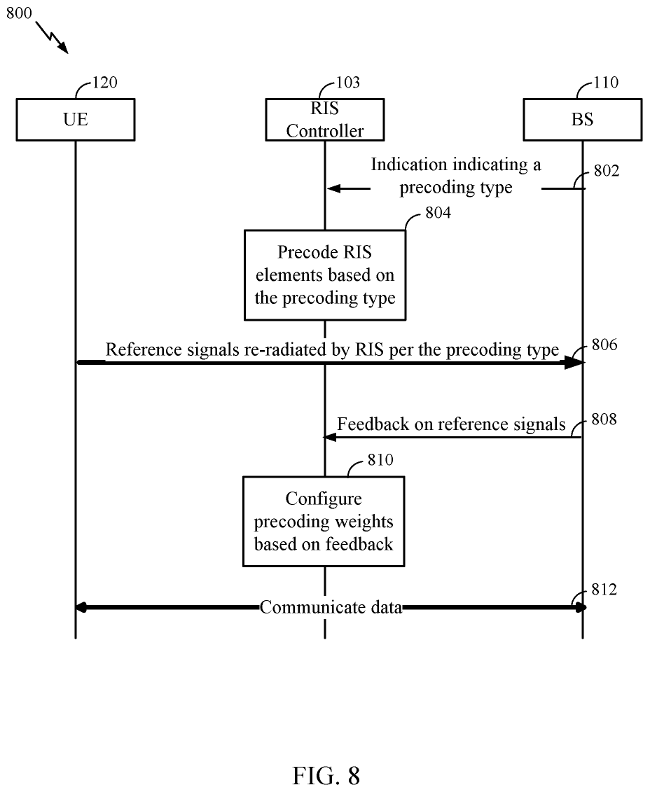

An example of details of operations 600 and 700 is further illustrated in the call flow diagram 800 in FIG. 8, which shows example signaling and operations of the UE 120, the RIS controller 103, and the BS 110.

At 802, the BS 110 transmits to the RIS controller 103 an indication indicating at least one precoding type to use for precoding RIS elements associated with the RIS controller 103.

In some aspects, the indication indicates to use the at least one precoding type for precoding the one or more communication elements until the wireless communication device transmits a second indication indicating at least one second precoding type to use for precoding the one or more communication elements.

In some aspects, to transmit the indication indicating the at least one precoding type further comprises to transmit a second indication indicating at least one time period for using the at least one precoding type for precoding the one or more communication elements. The at least one time period may be specified or represented in a number of symbols, slots, or any applicable time units. In some cases, the indication may be transmitted using one or more of radio resource control (RRC) signaling, a media access control-control element (MAC-CE), downlink control information (DCI), or sidelink control information (SCI).

In some aspects, the indication further indicates a first identifier associated with the other computing device, a second identifier associated with the computing device, a threshold number of computing devices served by the computing device, a quality of service, a third identifier associated with a service, or a fourth identifier associated with an application. The one or more of the above identifiers may be associated with the at least one precoding type (i.e., codebook based or non-codebook based). For example, the wireless communication device may pair the precoding type based on receiving node IDs, the service or application currently supported, or a number of UEs to be served. Once the RIS receives the receiving node IDs or the indication of service or the number of receiving nodes being service within a time period, the RIS would know which precoding type to use.

At 804, the RIS controller 103 precodes the one or more communication elements (e.g., of RIS 104) based on the indication indicating the at least one precoding type. In some cases, to precode the one or more communication elements includes to adjust at least one of a phase or amplitude gain for at least one of the one or more communication elements according to a respective precoding weight value determined based on the at least one precoding type.

At 806, the UE 120 transmits one or more reference signals, which are re-radiated by the RIS elements of the RIS 104 per the precoding type, to the BS 110.

At 808, the BS 110 provides feedback on the reference signals to the RIS controller 103. For example, the feedback may include one or more received metrics, such as a signal strength, an energy level, a signal to noise ratio (SNR), a channel quality indicator (CQI), or a reference signal received power (RSRP). The feedback may be an indication of a particular RS.

At 810, the RIS controller 103 configures the precoding weights based on the feedback from the BS 110. For example, the RIS controller 103 selects a precoding weight associated with the RS indicated in the feedback, such as through an express indicator of the RS, an optimal metric value associated with the RS, etc. The configuration may include updating the precoding weights based on newly generated codebook for both codebook based and non-codebook based precodings. In some cases, the feedback may include one or more parameters used to generate the codebook or selecting part of the codebook to apply to a subset of the RIS elements.

Operations 802-810 may loop or repeat in a closed-loop operation until an ideal set of precoding weights (e.g., the settings that maximizes the received metrics measured at the BS 110) has been identified. At this point, the RIS 104 may be considered completed training and may optimally perform until conditions related to the UE 120 and BS 110 are changed (such as location change or beam change due to new blockage).

In certain aspects, the BS 110 may also transmit, to the RIS controller 103, an index value corresponding to a set of precoding weights of a plurality of sets of precoding weights to use for the one or more communication elements to communicate with the wireless communication device. The index value may be used to identify certain precoding settings corresponding to certain conditions, such that when the conditions recur, the RIS controller may recall the settings using the index value.

At 812, the UE 120 communicates data with the BS 110 via the trained RIS 104.

The call flow diagram 800 is implemented with the BS 110 as the wireless communication device in operations 600 as an example.

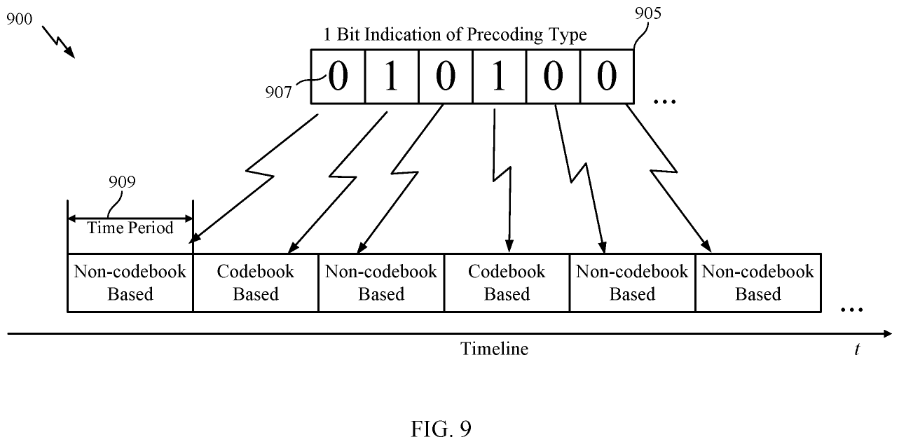

FIG. 9 illustrates an example signaling 900 for configuring different precoding types, in accordance with certain aspects of the present disclosure. In certain aspects, the indication about the precoding types may include a sequence of values 905 (e.g., 0 and 1, or the like), each value 907 indicating a corresponding precoding type and each value 907 associated with a corresponding time period 909, based on a corresponding position of the value 907 in the sequence of values 905, for using the corresponding precoding type for precoding the one or more RIS elements.

The wireless communication device may also signal the duration of the time period 909 for each precoding type. For example, the wireless communication device may transmit a second indication indicating at least one duration for the corresponding time periods. In some cases, the at least one duration includes a first duration for values associated with non-codebook based precoding and a second value for each corresponding time period associated with a value indicating codebook based precoding.

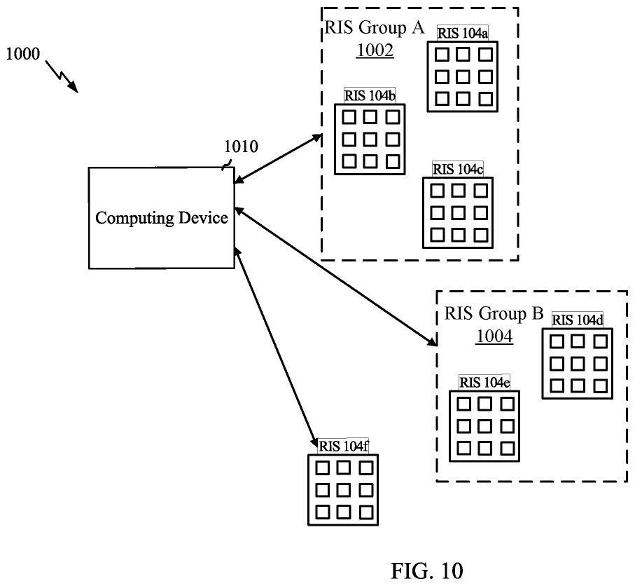

FIG. 10 illustrates an example configuration 1000 of RIS groups, in accordance with certain aspects of the present disclosure. For example, MS 104 may be grouped into different groups of RISs, and each group may be associated with a corresponding group identifier (ID). Accordingly, an indication of a precoding type transmitted by a wireless communication device 1010 may include a group ID, and each MS 104 that receives the precoding type that is part of the group referenced by the group ID then uses the precoding type for performing precoding.

For example, in FIG. 10, RISs 104a, 104b, and 104c may share a same group ID of RIS Group A 1002. The computing device 1010 may send the same indication to the respective RISs 104a, 104b, and 104c of RIS Group A 1002. Similarly, RISs 104d and 104e may share another group ID of RIS Group B 1004. The computing device 1010 may indicate the precoding types indication to the RIS Group B 1004. The computing device 1010 may also directly send indications to individual RISs, such as the RIS 104f.

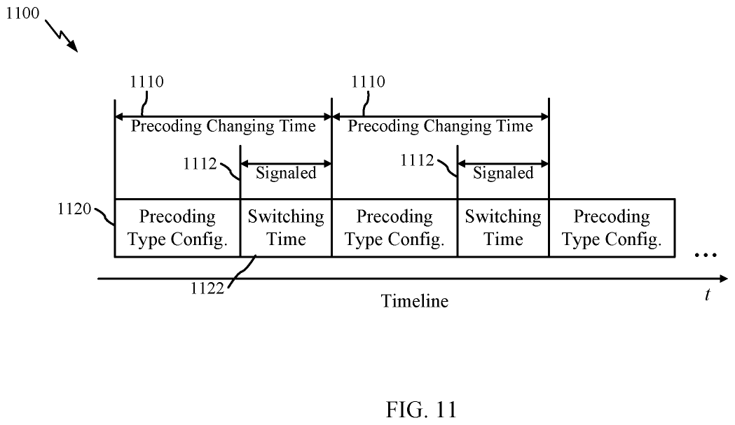

FIG. 11 illustrates an example indication 1100 of switching time, in accordance with certain aspects of the present disclosure. In some aspects, a wireless communication device may receive a second indication of a switching time for the one or more RIS elements to be precoded with different precoding types. For example, a RIS controller may identify, measure, and/or recode a switching time and signal it to the wireless communication device. As such, the wireless communication device knows, as shown in FIG. 11, the total precoding changing time 1110 with consideration for the signaled switching time 1112. The wireless communication device may then transmit the indication indicating the at least one precoding type 1120 and a second indication indicating the switching time 1122 for using the at least one precoding type for precoding the RIS elements.

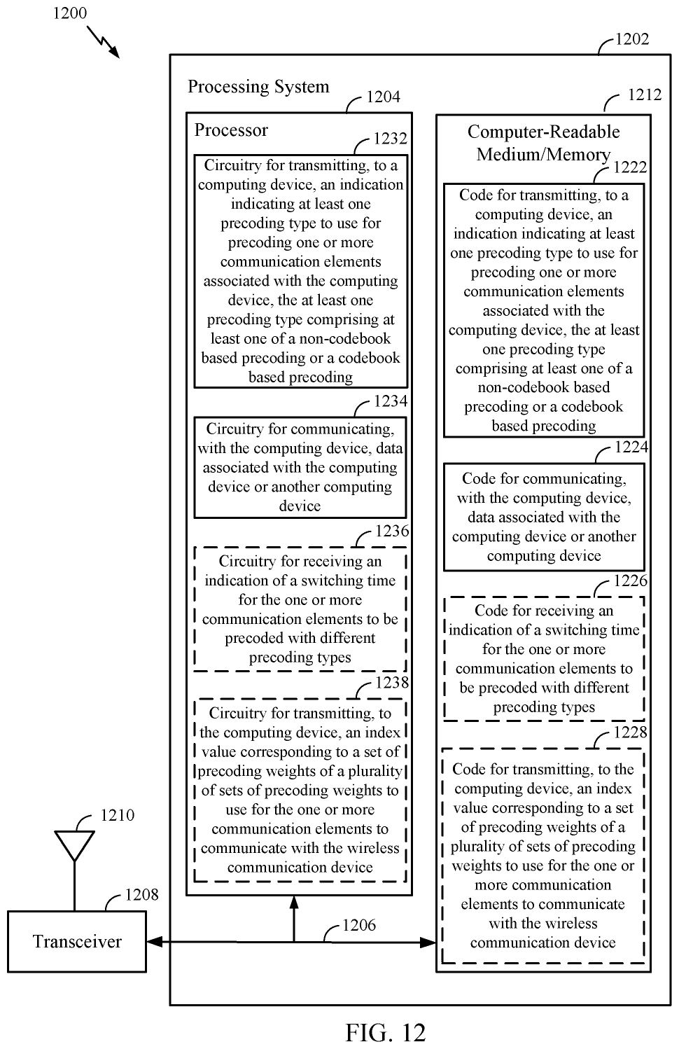

FIG. 12 illustrates a communications device 1200 that may include various components (e.g., corresponding to means-plus-function components) configured to perform operations for the techniques disclosed herein, such as the operations illustrated in FIG. 6. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 6, or other operations for performing the various techniques discussed herein for indicating precoding types for communication elements. In certain aspects, computer-readable medium/memory 1212 stores code 1222 for transmitting, to a computing device, an indication indicating at least one precoding type to use for precoding one or more communication elements associated with the computing device, the at least one precoding type comprising at least one of a non-codebook based precoding or a codebook based precoding; code 1224 for communicating, with the computing device, data associated with the computing device or another computing device; optional code 1226 for receiving an indication of a switching time for the one or more communication elements to switch between using different precoding types; and optional code 1228 for transmitting, to the computing device, an index value corresponding to a set of precoding weights of a plurality of sets of precoding weights to use for the one or more communication elements to communicate with the wireless communication device. In certain aspects, the processor 1204 has circuitry configured to implement the code stored in the computer-readable medium/memory 1212. The processor 1204 includes circuitry 1232 for transmitting, to a computing device, an indication indicating at least one precoding type to use for precoding one or more communication elements associated with the computing device, the at least one precoding type comprising at least one of a non-codebook based precoding or a codebook based precoding; circuitry 1234 for communicating, with the computing device, data associated with the computing device or another computing device; optional circuitry 1236 for receiving an indication of a switching time for the one or more communication elements to switch between using different precoding types; and optional circuitry 1238 for transmitting, to the computing device, an index value corresponding to a set of precoding weights of a plurality of sets of precoding weights to use for the one or more communication elements to communicate with the wireless communication device.

In certain aspects, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1236 for transmitting, to a computing device, an indication indicating at least one precoding type to use for precoding one or more communication elements associated with the computing device, the at least one precoding type comprising at least one of a non-codebook based precoding or a codebook based precoding, and/or circuitry 1238 for transmitting, to the computing device, an index value corresponding to a set of precoding weights of a plurality of sets of precoding weights to use for the one or more communication elements to communicate with the wireless communication device of the communication device 1200 in FIG. 12. Means for receiving (or means for obtaining or means for measuring) may include a receiver and/or an antenna(s) 234 of the BS 110a or a receiver and/or antenna(s) 252 of the UE 120a illustrated in FIG. 2 and/or circuitry 1236 for receiving an indication of a switching time for the one or more communication elements to switch between using different precoding types of the communication device 1200 in FIG. 12. Means for communicating may include a transmitter, a receiver or both, and/or the circuitry 1234 for communicating, with the computing device, data associated with the computing device or another computing device of the communication device 1200 in FIG. 12. Means for generating, means for performing, means for determining, means for taking action, means for determining, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1202 of the communication device 1200 in FIG. 12.

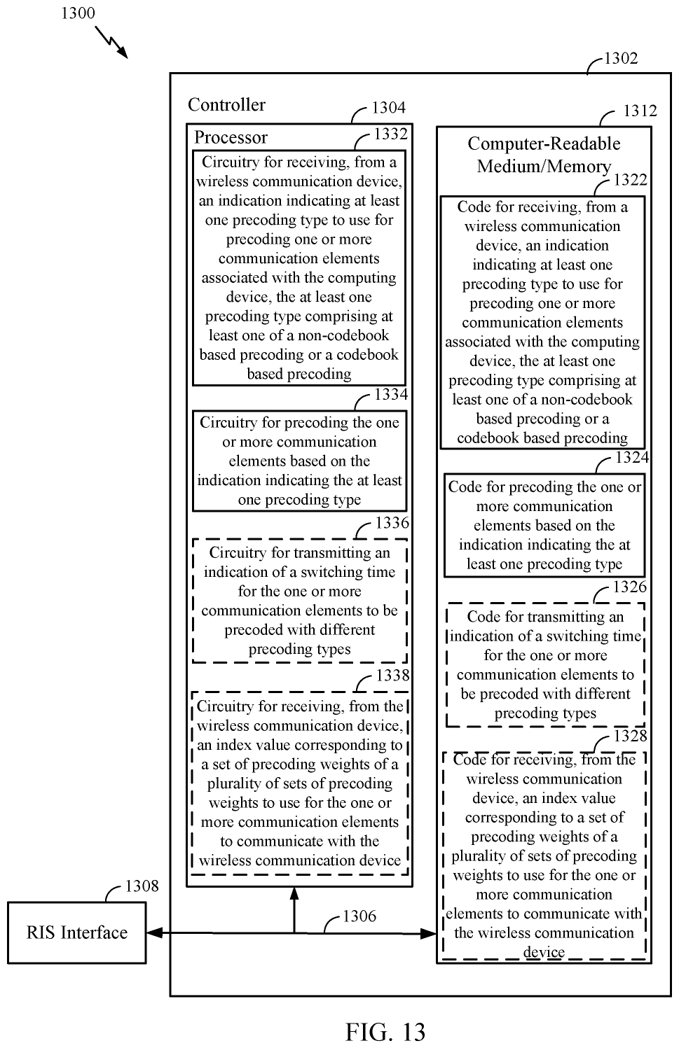

FIG. 13 illustrates a communications device 1300 that may include various components (e.g., corresponding to means-plus-function components) configured to perform operations for the techniques disclosed herein, such as the operations illustrated in FIG. 7. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 7, or other operations for performing the various techniques discussed herein for Indicating precoding types for communication elements. In certain aspects, computer-readable medium/memory 1312 stores code 1322 for receiving, from a wireless communication device, an indication indicating at least one precoding type to use for precoding one or more communication elements associated with the computing device, the at least one precoding type comprising at least one of a non-codebook based precoding or a codebook based precoding; code 1324 for precoding the one or more communication elements based on the indication indicating the at least one precoding type; optional code 1326 for transmitting an indication of a switching time for the one or more communication elements to switch between using different precoding types; and optional code 1328 for receiving, from the wireless communication device, an index value corresponding to a set of precoding weights of a plurality of sets of precoding weights to use for the one or more communication elements to communicate with the wireless communication device. In certain aspects, the processor 1304 has circuitry configured to implement the code stored in the computer-readable medium/memory 1312. The processor 1304 includes circuitry 1332 for receiving, from a wireless communication device, an indication indicating at least one precoding type to use for precoding one or more communication elements associated with the computing device, the at least one precoding type comprising at least one of a non-codebook based precoding or a codebook based precoding; circuitry 1334 for precoding the one or more communication elements based on the indication indicating the at least one precoding type; optional circuitry 1336 for transmitting an indication of a switching time for the one or more communication elements to switch between using different precoding types; optional circuitry 1338 for receiving, from the wireless communication device, an index value corresponding to a set of precoding weights of a plurality of sets of precoding weights to use for the one or more communication elements to communicate with the wireless communication device.

In certain aspects, means for transmitting (or means for outputting for transmission) may include a transmitter and/or an antenna(s) 234 or the BS 110a or the transmitter unit 254 and/or antenna(s) 252 of the UE 120a illustrated in FIG. 2, circuitry 1336 for transmitting an indication of a switching time for the one or more communication elements to switch between using different precoding types of the communication device 1300 in FIG. 13. Means for receiving (or means for obtaining or means for measuring) may include a receiver and/or an antenna(s) 234 of the BS 110a or a receiver and/or antenna(s) 252 of the UE 120a illustrated in FIG. 2, circuitry 1332 for receiving, from a wireless communication device, an indication indicating at least one precoding type to use for precoding one or more communication elements associated with the computing device, the at least one precoding type comprising at least one of a non-codebook based precoding or a codebook based precoding, and/or circuitry 1338 for receiving, from the wireless communication device, an index value corresponding to a set of precoding weights of a plurality of sets of precoding weights to use for the one or more communication elements to communicate with the wireless communication device of the communication device 1300 in FIG. 13. Means for communicating may include a transmitter, a receiver or both. Means for precoding, means for generating, means for performing, means for determining, means for taking action, means for determining, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2, and/or the circuitry 1334 for precoding the one or more communication elements based on the indication indicating the at least one precoding type, and/or the processing system 1302 of the communication device 1300 in FIG. 13.

### Example Aspects

Aspect 1: A wireless communication device comprising: a memory; and a processor coupled to the memory, the memory and the processor being configured to: transmit, to a computing device, an indication indicating at least one precoding type to use for precoding one or more communication elements associated with the computing device, the at least one precoding type comprising at least one of a non-codebook based precoding or a codebook based precoding; and communicate, with the computing device, data associated with the computing device or another computing device.

Aspect 2: The wireless communication device of Aspect 1, wherein the indication indicates to use the at least one precoding type for precoding the one or more communication elements until the wireless communication device transmits a second indication indicating at least one second precoding type to use for precoding the one or more communication elements.

Aspect 3: The wireless communication device of either Aspect 1 or 2, wherein the memory and the processor being configured to transmit the indication indicating the at least one precoding type comprises the memory and the processor being configured to transmit a second indication indicating at least one time period for using the at least one precoding type for precoding the one or more communication elements.

Aspect 4: The wireless communication device of any one of Aspects 1 to 3, wherein the indication comprises a sequence of values, each value indicating a corresponding precoding type and each value being associated with a corresponding time period, based on a corresponding position of the value in the sequence, for using the corresponding precoding type for precoding the one or more communication elements.

Aspect 5: The wireless communication device of any one of Aspects 1 to 4, wherein the memory and the processor being configured to transmit the indication indicating the at least one precoding type comprises the memory and the processor being configured to transmit a second indication indicating at least one duration for the corresponding time periods.

Aspect 6: The wireless communication device of any one of Aspects 1 to 5, wherein the at least one duration comprises a first duration for values associated with non-codebook based precoding and a second duration for each corresponding time period associated with a value indicating codebook based precoding.

Aspect 7: The wireless communication device of any one of Aspects 1 to 6, wherein the indication comprises a group identifier, and wherein the computing device is one of a plurality of computing devices associated with the group identifier and configured to use the at least one precoding type for precoding.

Aspect 8: The wireless communication device of any one of Aspects 1 to 7, wherein the indication further indicates an identifier associated with the other computing device, an identifier associated with the computing device, a threshold number of computing devices served by the computing device, a quality of service, an identifier associated with a service, or an identifier associated with an application, wherein the identifier is associated with the at least one precoding type.

Aspect 9: The wireless communication device of any one of Aspects 1 to 8, wherein the memory and the processor are configured to receive a second indication of a switching time for the one or more communication elements to switch between using different precoding types.

Aspect 10: The wireless communication device of any one of Aspects 1 to 9, wherein to transmit the indication indicating the at least one precoding type further comprises to transmit a second indication indicating at least one time period for using the at least one precoding type for precoding the one or more communication elements, the at least one time period based on the switching time.

Aspect 11: The wireless communication device of any one of Aspects 1 to 10, wherein the indication is transmitted using one or more of radio resource control (RRC) signaling, a media access control-control element (MAC-CE), downlink control information (DCI), or sidelink control information (SCI).

Aspect 12: The wireless communication device of any one of Aspects 1 to 11, wherein the memory and the processor are further configured to: transmit, to the computing device, an index value corresponding to a set of precoding weights of a plurality of sets of precoding weights to use for the one or more communication elements to communicate with the wireless communication device.

Aspect 13: The wireless communication device of any one of Aspects 1 to 12, wherein the wireless communication device comprises one of a base station or a user equipment, wherein the computing device comprises one of a base station, a user equipment, or a controller of a reconfigurable intelligent surface (RIS), and wherein the other computing device comprises one of a base station or a user equipment.

Aspect 14: The wireless communication device of any one of Aspects 1 to 13, wherein the one or more communication elements comprise one of: one or more antennas or one or more RIS elements.

Aspect 15: A computing device comprising: a memory; and a processor coupled to the memory, the memory and the processor being configured to: receive, from a wireless communication device, an indication indicating at least one precoding type to use for precoding one or more communication elements associated with the computing device, the at least one precoding type comprising at least one of a non-codebook based precoding or a codebook based precoding; and precode the one or more communication elements based on the indication indicating the at least one precoding type.

Aspect 16: The computing device of Aspect 15, wherein the memory and the processor being configured to precode the one or more communication elements comprises the memory and the processor being configured to adjust at least one of a phase or amplitude gain for at least one of the one or more communication elements according to a respective precoding weight value determined based on the at least one precoding type.

Aspect 17: The computing device of Aspect 15 or 16, wherein the indication indicates to use the at least one precoding type for precoding the one or more communication elements until the computing device receives a second indication indicating at least one second precoding type to use for precoding the one or more communication elements.

Aspect 18: The computing device of any one of Aspects 15 to 17, wherein the memory and the processor being configured to receive the indication indicating the at least one precoding type comprises the memory and the processor being configured to receive a second indication indicating at least one time period for using the at least one precoding type for precoding the one or more communication elements.

Aspect 19: The computing device of any one of Aspects 15 to 18, wherein the indication comprises a sequence of values, each value indicating a corresponding precoding type and each value being associated with a corresponding time period, based on a corresponding position of the value in the sequence, for using the corresponding precoding type for precoding the one or more communication elements.

Aspect 20: The computing device of any one of Aspects 15 to 19, wherein the memory and the processor being configured to receive the indication indicating the at least one precoding type comprises the memory and the processor being configured to receive a second indication indicating at least one duration for the corresponding time periods.

Aspect 21: The computing device of any one of Aspects 15 to 20, wherein the at least one duration comprises a first duration for values associated with non-codebook based precoding and a second duration for each corresponding time period associated with a value indicating codebook based precoding.

Aspect 22: The computing device of any one of Aspects 15 to 21, wherein the indication comprises a group identifier, and wherein the computing device is one of a plurality of computing devices associated with the group identifier and configured to use the at least one precoding type for precoding.

Aspect 23: The computing device of any one of Aspects 15 to 22, wherein the indication further indicates an identifier associated with another computing device, an identifier associated with the computing device, a threshold number of computing devices served by the computing device, a quality of service, an identifier associated with a service, or an identifier associated with an application, wherein the identifier is associated with the at least one precoding type.

Aspect 24: The computing device of any one of Aspects 15 to 23, wherein the memory and the processor are configured to transmit an indication of a switching time for the one or more communication elements to switch between using different precoding types.

Aspect 25: The computing device of any one of Aspects 15 to 24, wherein the memory and the processor being configured to receive the indication indicating the at least one precoding type comprises the memory and the processor being configured to receive a second indication indicating at least one time period for using the at least one precoding type for precoding the one or more communication elements, the at least one time period based on the switching time.

Aspect 26: The computing device of any one of Aspects 15 to 25, wherein the indication is received using one or more of radio resource control (RRC) signaling, a media access control-control element (MAC-CE), downlink control information (DCI), or sidelink control information (SCI).

Aspect 27: The computing device of any one of Aspects 15 to 26, wherein the memory and the processor are further configured to: receive, from the wireless communication device, an index value corresponding to a set of precoding weights of a plurality of sets of precoding weights to use for the one or more communication elements to communicate with the wireless communication device.

Aspect 28: A method for wireless communications by a wireless communication device, comprising: transmitting, to a computing device, an indication indicating at least one precoding type to use for precoding one or more communication elements associated with the computing device, the at least one precoding type comprising at least one of a non-codebook based precoding or a codebook based precoding; and communicating, with the computing device, data associated with the computing device or another computing device.

Aspect 29: A method for wireless communications by a computing device, comprising: receiving, from a wireless communication device, an indication indicating at least one precoding type to use for precoding one or more communication elements associated with the computing device, the at least one precoding type comprising at least one of a non-codebook based precoding or a codebook based precoding; and precoding the one or more communication elements based on the indication indicating the at least one precoding type.

Aspect 30: The method of Aspect 29, further comprising adjusting at least one of a phase or amplitude gain for at least one of the one or more communication elements according to a respective precoding weight value determined based on the at least one precoding type.

Aspect 31: A user equipment (UE) comprising: one or more means for performing the method of Aspect 28.

Aspect 32: A user equipment (UE) comprising: one or more means for performing the method of any of Aspects 29-30.

Aspect 33: A non-transitory computer-readable storage medium having instructions stored thereon for performing the method of Aspect 28 for wireless communication by a wireless communication device.

Aspect 34: A non-transitory computer-readable storage medium having instructions stored thereon for performing the method of any of Aspects 29-30 for wireless communication by a computing device.

Aspect 35: The device of any of Aspects 1-27, wherein the at least one of the non-codebook based precoding or the codebook based precoding comprises the non-codebook based precoding.

Aspect 36: The device of any of Aspects 1-27, wherein the at least one of the non-codebook based precoding or the codebook based precoding comprises the codebook based precoding.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions in any suitable electromagnetic spectrum. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 6 and FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication at a wireless communication device comprising:
one or more memories; and
one or more processors coupled to the one or more memories and configured to cause the wireless communication device to:
transmit an indication indicating at least one precoding type to use for precoding one or more communication elements associated with a computing device, the at least one precoding type comprising at least one of a non-codebook based precoding or a codebook based precoding; and
communicate, with the computing device, data associated with the computing device or another computing device.

2. The apparatus of claim 1, wherein the indication indicates to use the at least one precoding type for precoding the one or more communication elements until the wireless communication device transmits a second indication indicating at least one second precoding type to use for precoding the one or more communication elements.

3. The apparatus of claim 1, wherein to transmit the indication indicating the at least one precoding type, the one or more processors are configured to cause the wireless communication device to transmit a second indication indicating at least one time period for using the at least one precoding type for precoding the one or more communication elements.

4. The apparatus of claim 1, wherein the indication comprises a sequence of values, each value indicating a corresponding precoding type and each value being associated with a corresponding time period for using the corresponding precoding type.

5. The apparatus of claim 4, wherein to transmit the indication indicating the at least one precoding type, the one or more processors are configured to cause the wireless communication device to transmit a second indication indicating at least one duration for the corresponding time periods.

6. The apparatus of claim 5, wherein the at least one duration comprises a first duration for each corresponding time period associated with a value indicating non-codebook based precoding and a second duration for each corresponding time period associated with a value indicating codebook based precoding.

7. The apparatus of claim 1, wherein the indication comprises a group identifier, and wherein the computing device is one of a plurality of computing devices associated with the group identifier.

8. The apparatus of claim 1, wherein the indication further indicates a first identifier associated with the other computing device, a second identifier associated with the computing device, a threshold number of computing devices served by the computing device, a quality of service, a third identifier associated with a service, or a fourth identifier associated with an application.

9. The apparatus of claim 1, wherein the one or more processors are further configured to cause the wireless communication device to receive a second indication of a switching time for the one or more communication elements to switch between using different precoding types.

10. The apparatus of claim 9, wherein to transmit the indication indicating the at least one precoding type comprises the one or more processors are configured to cause the wireless communication device to transmit a third indication indicating at least one time period for using the at least one precoding type for precoding the one or more communication elements, the at least one time period based on the switching time.

11. The apparatus of claim 1, wherein the indication is transmitted using one or more of radio resource control (RRC) signaling, a media access control-control element (MAC-CE), downlink control information (DCI), or sidelink control information (SCI).

12. The apparatus of claim 1, wherein the one or more processors are further configured to cause the wireless communication device to:
transmit an index value corresponding to a set of precoding weights of a plurality of sets of precoding weights to use for the one or more communication elements to communicate with the wireless communication device.

13. The apparatus of claim 1, wherein the wireless communication device comprises one of a base station or a user equipment, wherein the computing device comprises one of a base station, a user equipment, or a controller of a reconfigurable intelligent surface (RIS), and wherein the other computing device comprises one of a base station or a user equipment.

14. The apparatus of claim 13, wherein the one or more communication elements comprise one of: one or more antennas or one or more RIS elements.

15. An apparatus for wireless communication at a computing device comprising:
one or more memories; and
one or more processors coupled to the one or more memories and configured to cause the computing device to:
receive an indication indicating at least one precoding type to use for precoding one or more communication elements associated with the computing device, the at least one precoding type comprising at least one of a non-codebook based precoding or a codebook based precoding; and
precode the one or more communication elements based at least on the indication indicating the at least one precoding type.

16. The apparatus of claim 15, wherein to precode the one or more communication elements, the one or more processors are configured to cause the computing device to adjust at least one of a phase or amplitude gain for at least one of the one or more communication elements according to a respective precoding weight value determined based on the at least one precoding type.

17. The apparatus of claim 15, wherein the indication indicates to use the at least one precoding type for precoding the one or more communication elements until the computing device receives a second indication indicating at least one second precoding type to use for precoding the one or more communication elements.

18. The apparatus of claim 15, wherein to receive the indication indicating the at least one precoding type, the one or more processors are configured to cause the computing device to receive a second indication indicating at least one time period for using the at least one precoding type for precoding the one or more communication elements.

19. The apparatus of claim 15, wherein the indication comprises a sequence of values, each value indicating a corresponding precoding type and each value being associated with a corresponding time period for using the corresponding precoding type.

20. The apparatus of claim 19, wherein to receive the indication indicating the at least one precoding type, the one or more processors are configured to cause the computing device to receive a second indication indicating at least one duration for the corresponding time periods.

21. The apparatus of claim 20, wherein the at least one duration comprises a first duration for each corresponding time period associated with a value indicating non-codebook based precoding and a second duration for each corresponding time period associated with a value indicating codebook based precoding.

22. The apparatus of claim 15, wherein the indication comprises a group identifier, and wherein the computing device is one of a plurality of computing devices associated with the group identifier.

23. The apparatus of claim 15, wherein the indication further indicates a first identifier associated with another computing device, a second identifier associated with the computing device, a threshold number of computing devices served by the computing device, a quality of service, a third identifier associated with a service, or a fourth identifier associated with an application.

24. The apparatus of claim 15, wherein the one or more processors are configured to cause the computing device to transmit an indication of a switching time for the one or more communication elements to switch between using different precoding types.

25. The apparatus of claim 24, wherein to receive the indication indicating the at least one precoding type, the one or more processors are configured to cause the computing device to receive a second indication indicating at least one time period for using the at least one precoding type for precoding the one or more communication elements, the at least one time period based on the switching time.

26. The apparatus of claim 15, wherein the indication is received using one or more of radio resource control (RRC) signaling, a media access control-control element (MAC-CE), downlink control information (DCI), or sidelink control information (SCI).

27. The apparatus of claim 15, wherein the one or more processors are further configured to cause the computing device to:
receive an index value corresponding to a set of precoding weights of a plurality of sets of precoding weights to use for the one or more communication elements to communicate with a wireless communication device.

28. A method for wireless communications at a wireless communication device, comprising:
transmitting an indication indicating at least one precoding type to use for precoding one or more communication elements associated with the computing device, the at least one precoding type comprising at least one of a non-codebook based precoding or a codebook based precoding; and
communicating, with a computing device, data associated with the computing device or another computing device.

29. A method for wireless communications by at a computing device, comprising:
receiving an indication indicating at least one precoding type to use for precoding one or more communication elements associated with the computing device, the at least one precoding type comprising at least one of a non-codebook based precoding or a codebook based precoding; and
precoding the one or more communication elements based at least on the indication indicating the at least one precoding type.

30. The method of claim 29, further comprising adjusting at least one of a phase or amplitude gain for at least one of the one or more communication elements according to a respective precoding weight value determined based on the at least one precoding type.
